(19) United States
(12) Patent Application Publication
(10) Pub. No.: US 2007/0269641 A1
(43) Pub. Date: Nov. 22, 2007

(54) Solvent Stable Tinted Iridescent Film

(76) Inventors: Daniel J. Graney, LaGrangeville, NY (US); Kenneth W. Parkman, Mooresville, NC (US); Roland Valin, Cranbury, NJ (US)

Correspondence Address: Chief Patent Counsel;Engelhard Corporation, 101 Wood Avenue, P O Box 770, Iselin, NJ, 08830-0770, US

(21) Appl. No.: 10/567,390

(22) PCT Filed: Aug. 6, 2004
(86) PCT No.: PCT/US04/25436

§ 371 Date: Jun. 28, 2007

Related U.S. Application Data
(60) Provisional application No. 60/496,073, filed on Aug. 18, 2003.

(51) Int. Cl. B41M 5/00

(52) U.S. Cl. 428/204; 428/195.1

(57) ABSTRACT

The present invention provides colored iridescent film comprising a core of substantially parallel layers wherein alternate of the layers comprise a first polymer and the remaining layers comprise a second polymer and at least one of the layers contains organic pigment. The present colored iridescent film may advantageously be used in decorative applications such as glitter.

### BACKGROUND OF THE INVENTION

Multilayer polymeric films containing alternating layers of at least two polymers of different refractive indices are iridescent when the individual layers are of suitable thicknesses as disclosed by commonly assigned U.S. Pat. Nos. 5,451,449 and 5,837,359. Iridescent color is produced by the phenomenon of light interference. The optical core comprises the alternating polymeric layers. The layers on the outside of the core are known as the skin layer and may be made of the same or a different polymer than the core layers.

Incorporating tints into layers of iridescent films to change or enhance the reflection and transmission colors thereof is described in commonly assigned U.S. Pat. No. 5,451,449, where it is suggested that only organic dyes can be used to achieve the tint effect. One desired use for tinted iridescent film has been as tinted iridescent glitter incorporated into nail lacquer. Because nail lacquer contains solvent such as butyl acetate, the tinted iridescent glitter and thus, film used to make it cannot contain dyes that are unstable in the solvent and thus, bleed out of the film or glitter. Unfortunately, the C.I. Solvent Red 135 dye in one commercially available tinted iridescent film comprising 226 alternating layers of polybutylene terephthalate (hereinafter “PBT”) and polyethylene vinyl acetate (hereinafter “EVA”) upon exposure to butyl acetate bled out of the film into the solvent and thus, the film was no longer colored; see Comparative A below. In addition, the dye in commercially available tinted iridescent film comprising 115 alternating layers of polyethylene terephthalate (hereinafter “PET”) and polymethyl methacrylate (hereinafter “PMMA”) upon exposure to butyl acetate bled out of the film into the solvent and thus, the film was no longer colored. Also, the polymeric layers swelled and thus, the film was no longer iridescent; see Comparative B below. Similarly, the dye in commercially available tinted iridescent film comprising 226 alternating layers of PET and PMMA upon exposure to butyl acetate bled out of the film into the solvent and thus, the film was no longer colored. Also, the polymeric layers swelled and thus, the film was no longer iridescent; see Comparative C below. Similarly, the dye in commercially available tinted iridescent film comprising 226 alternating layers of PET and PMMA upon exposure to butyl acetate bled out and thus, the film was no longer colored; see Comparative D below. Thus, applications for the tinted iridescent films are limited.

In general, pigments have larger molecular structures and were thought to be unfeasible for use in microlayered optical films due to the potential for disruption of the optical core. The background of U.S. Pat. No. 5,451,449 discusses an attempt to incorporate pigment into an iridescent film. For first order colors, the layers of the optical core are between 0.03 and 0.2 microns; these thicknesses are smaller than the normal pigment particle size of 0.3 microns or larger. When these larger pigment particles were incorporated into the inner layers of the film, they distorted the physical structure of the layers resulting in loss of iridescence. However, when smaller pigment particle sizes are used, they agglomerate and form bigger particles resulting in similar color loss. In cases where agglomeration did not occur, the pigment contribution was inadequate and overpowered by the iridescent colors so that the film appeared as if no pigment had been added; when this concentration was exceeded, the loading levels were found to be too high for the resins to be drawn down to be cast into film. In an attempt to overcome these problems, pigments were placed in the skin layer having a thickness of 3-7 microns. However, the same problems were seen with lack of color or the inability to extrude the film.

Based on the limitations of commercially available tinted iridescent films, nail laquer manufacturers, suppliers, and users desire nail laquer containing colored iridescent glitter and thus, need colored iridescent film to form it.

### SUMMARY OF THE INVENTION

In response to the need in the industry, the present invention provides a colored iridescent film comprising a structure of substantially parallel layers wherein alternate of the layers comprise a first polymer and the remaining layers comprise a second polymer and at least one of the layers contains pigment. It has been discovered that certain organic pigments can be incorporated into specific polymers and then extruded without damaging the processability of the polymer. These pigments produced iridescent films with intense color and significantly improved stability when exposed to organic solvents as compared to the standard colorants.

The present invention also provides glitter comprised of colored iridescent film comprising a structure of substantially parallel layers wherein alternate of the layers comprise a first polymer and the remaining layers comprise a second polymer and at least one of the layers contains pigment.

The present invention also provides nail laquer containing glitter comprised of colored iridescent film comprising a structure of substantially parallel layers wherein alternate of the layers comprise a first polymer and the remaining layers comprise a second polymer and at least one of the layers contains pigment.

### BRIEF DESCRIPTION OF THE DRAWINGS:

FIG. 1 illustrates a cross section of the film of Inventive Example 1.

FIG. 2 illustrates a cross section of the film of Inventive Example 2.

FIG. 3 illustrates a cross section of the film of Inventive Example 3.

FIG. 4 illustrates a cross section of the film of Inventive Example 4.

FIG. 5 illustrates a cross section of the film of Inventive Example 5.

FIG. 6 illustrates a cross section of the film of Inventive Example 6.

FIG. 7 illustrates a cross section of the film of Inventive Example 7.

FIG. 8 illustrates a cross section of the film of Inventive Example 8.

FIG. 9 illustrates a cross section of the film of Inventive Example 9.

FIG. 10 illustrates a cross section of the film of Inventive Example 10.

FIG. 11 illustrates a cross section of the film of Inventive Example 11.

FIG. 12 illustrates a cross section of the film of Inventive Example 12.

FIG. 13 illustrates a cross section of the film of Inventive Example 17.

FIG. 14 illustrates a cross section of the film of Inventive Example 18.

FIG. 15 illustrates a cross section of the film of Inventive Example 19.

FIG. 16 illustrates a cross section of the film of Inventive Example 20.

FIG. 17 illustrates a cross section of the film of Inventive Example 21.

FIG. 18 illustrates a cross section of the film of Inventive Example 22.

FIG. 19 illustrates a cross section of the film of Inventive Example 23.

FIG. 20 illustrates a cross section of the film of Inventive Example 24.

### DETAILED DESCRIPTION OF THE INVENTION

The phrase “colored iridescent film” as used herein means upon exposure to butyl acetate, the film remains colored and iridescent.

Pigments:

Preferred pigments include carbon black, inorganic salts, and complex organic molecules like phthalocyanines, perylenes, quinacridones, and azo compounds such as disclosed in commonly assigned U.S. Pat. Nos. 5,669,967; 5,746,821; 5,677,435; and 5,747,571 incorporated herein by reference to the extent necessary.

In one embodiment, preferred azo pigments comprise one or more compounds characterized by Formula I below: 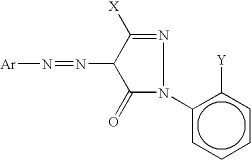
wherein X is a hydrocarbyl, carboxylic acid ester, sulfonic acid ester, carboxylic acid amide or sulfonic acid amide group; Y is a hydrocarbyl, halogen or hydrocarbyloxy group; and Ar is an aromatic moiety characterized by Formula II below: 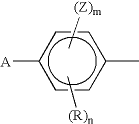
wherein A is a halogen group; each Z is independently a —COOH or —SO₃H group, or salts of such groups; m is 1 or 2; each R is independently a halogen, hydrocarbyl, hydrocarbyloxy, carboxylic acid ester, sulfonic acid ester, carboxylic amide, imidazolone, sulfonic acid amide or nitro group; and n is 0, 1 or 2.

These azo dyes are prepared by initially diazotizing one or more aromatic amines suitable for use in this invention containing at least one acid group or alkali metal or ammonium salts thereof to form a diazonium component and thereafter coupling the diazonium component with a coupling component comprised of a pyrazolone coupler suitable for use in this invention to form the desired dye.

Aromatic amines suitable for the purposes of the present invention are those characterized by Formula III below: 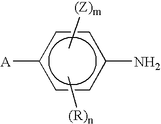
wherein A is a halogen group; each R is independently a halogen, hydrocarbyl, hydrocarbyloxy, carboxylic acid ester, sulfonic acid ester, carboxylic acid amide, imidazolone, sulfonic acid amide or nitro group; n is equal to 0, 1 or 2, each Z is independently a —COOH or —SO₃H group, or salts of such groups; and m is equal to 1 or 2.

The term “hydrocarbyl” as used in this specification is intended to include hydrocarbon groups which may contain substituent groups such as ether, ester, nitro, or halogen which do not materially affect the hydrocarbon character of the group.

The aromatic amines suitable for use in this invention have a para substituted halogen group and may contain 0, 1 or 2 R. groups which are each independently a halogen, hydrocarbyl, hydrocarbyloxy, carboxylic acid ester, sulfonic acid ester, carboxylic acid amide, imidazolone, sulfonic acid amide, or nitro group. The halogen group can be any of the halogens, although chlorine and bromine are generally used, with chlorine being the most preferred example of a halogen substituent. The hydrocarbyl groups may independently be alkyl, cycloalkyl, aryl, aralkyl, or alkaryl groups. For example, if R is an unsubstituted aryl group, the aromatic amine is a biphenyl amine. When R is an alkyl group, the alkyl group generally will contain from one to four carbon atoms. As used herein, “lower alkyl” shall mean those alkyl groups containing from 1 up to 4 carbon atoms. When R is a hydrocarbyloxy group, the hydrocarbyl moiety may be any of the hydrocarbyl groups discussed above, although the hydrocarbyloxy group generally is an alkoxy group containing from 1 to about 4 or more carbon atoms. Preferred R groups are methyl, ethyl, and chloro groups.

Suitable aromatic amines also contain one or two acid groups of —COOH and —SO₃H, or salts thereof. In one preferred embodiment, the aromatic amine contains an —SO₃H group or salts thereof. Preferably, these acid groups are adjacent (ortho) to the amine group.

Examples of aromatic amines wherein Z is a sulfonic acid group and m is 1 include 2-amino-5-chloro-4-ethylbenzene-1-sulfonic acid; 2-amino-5-chloro-4-methylbenzene-1 sulfonic acid; 2-amino-5-chlorobenzene-1-sulfonic acid; 2-amino-4,5-dichlorobenzene-1-sulfonic acid; 2-amino-5-bromo-4-ethylbenzene-1-sulfonic acid; etc.

Examples of aromatic amines wherein Z is a carboxylic acid group, and m is 1 include 2-amino-5-chloro-4-methoxybenzoic acid, 2-amino-5-chloro-4-methylbenzoic acid, etc. The sulfonic acid and carboxylic acid substituted aromatic amines can be used per se or as their salts. Examples of preferred salts include the alkali metal salts such as the sodium and potassium salts. Mixtures of two or more of any aromatic amines may be used.

The diazotization of the aromatic amines may be carried out in the manners known to those skilled in the art through the use of alkali metal nitrites or lower alkyl nitrites together with an adequately strong acid such as a mineral acid. Examples of useful mineral acid include hydrochloric acid and sulfuric acid. Nitrosyl sulfuric acid can also be utilized. The diazotization reaction can be conducted at a temperature in the range of from about −20 to +30° C., preferably from 0 to 20° C. Although not required, it may be advantageous in some of the diazotization reactions (and in the subsequent coupling reactions) to include a surface-active agent such as a non-ionic, anionic or cationic surface active agent and, optionally, appropriate organic solvents such as, for example, glacial acetic acid, lower alkanols, dioxane, formamide, dimethyl formamide, dimethyl sulfoxide, pyridine or N-methyl pyrrolidone.

The pyrazolone couplers useful for the purposes of this invention are represented by Formula IV below: 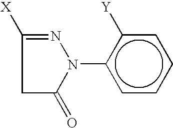
wherein X is a hydrocarbyl, carboxylic acid ester, sulfonic acid ester, carboxylic acid amide, or sulfonic acid amide group; Y is a hydrocarbyl, halogen, or hydrocarbyloxy group. Hydrocarbyloxy groups generally contain from 1 up to about 4 carbon atoms. Typically, X is a lower alkyl group containing one or two carbon atoms and is preferably an ethyl group. A useful X group is also a carboxylic acid ester of an alcohol containing 1 or 2 carbon atoms and is preferably an ethyl ester group. Another useful X group is an aryl group, preferably a phenyl group.

Typically, Y is a lower alkyl or halogen group. The halogen group can be any of the halogens, although chlorine and bromine are generally used, with chlorine being the most preferred example of a halogen substituent. Usually, the lower alkyl groups contain one or two carbon atoms and a methyl group is preferred substituent. A particularly useful embodiment is when Y is a methyl group.

Examples of the pyrazolone couplers useful for the purposes of this invention include 1-(2′-methylphenyl)-3-methyl-5-pyrazolone, 1-(2′-chlorophenyl)-3-methyl-5-pyrazolone, 1-(2′-methoxyphenyl)-3-methyl-5-pyrazolone, 1-(2′-methylphenyl)-3-carbethoxy-5-pyrazolone, etc. Mixtures of two or more of any of the pyrazolone components may be used.

A useful coupling reaction may be effected preferably by adding the diazonium components to coupling components, but the coupling components can be added to the diazonium components. Coupling is generally effected at a temperature of from about −20 to about 80° C., preferably from about 20 to about 65° C. As in a diazotization reaction, coupling may be carried out in the presence of an appropriate surface active agent or organic solvent, such as all of those identified above for the diazotization reaction.

The coupling component may be dissolved in a basic solution such as an aqueous alkali metal hydroxide solution and reprecipitated with a dilute acid such as acetic acid.

Generally, the diazonium component is coupled with a slight stoichiometric excess of the coupling component. That is, one equivalent of the diazonium component is coupled with slightly more than one equivalent of the coupling component.

The dispersibility of the pigments of the present invention can be improved by adding alkali-soluble resin-like products before, during, or after the coupling is completed or after the metallization discussed below. Various resin-like materials can be added for this purpose, and these include for example, rosin resins, polymeric rosins, resin soap, chemically modified rosin resins such as rosin-maleinate resins, alkyd resins, and other synthetic hydrocarbon resins with a higher acid number, or combination of these resins. The resins may be present in a product with free carboxyl groups that are capable of forming a salt, or may be partially or completely in the form of salts, for example, with alkali metal ions. It may also be advantageous to perform the coupling reaction in the presence of a finely divided insoluble material, for example, alkaline earth metal sulphates and carbonates, titanium dioxide or clay materials or very finely divided organic plastic materials.

The azo dye composition prepared by the above-described coupling reaction can be metallized by a divalent metal salt which forms the sulfonate or carboxylate salt. This is also known as laking and forms the azo pigment. The metal salt may be a salt of alkaline earth metals, manganese, nickel or zinc or mixtures of two or more of these metals. Alkaline earth metal salts are preferred. Alkaline earth metal salts such as SrC1₂ and CaC1₂ are particularly useful for this purpose. Metallization may be accomplished preferably by adding the metal salt to the dye after coupling of all the diazonium component present is complete or, by including the metal salt in the diazonium component whereby metallization occurs as the dye is formed.

In most applications, it is desirable, in order to achieve the full brightness and tinctorial strength, to heat the azo pigment. For example, the product of the metallization may be heated to reflux temperature for about 1 to 3 hours or at temperatures above 100° C. under pressure in the presence of the above-described resin soaps or other soluble resins.

After completion of the metallization, the azo pigments are recovered from the water-based reaction slurry by filtering to form a presscake of pigment which is washed with hot (e.g., 40-60° C.) water so as to remove the excess acids, bases and salts formed in the coupling reaction. The presscake is typically washed with from about 10 to 20 times its volume of hot water. The filter cake is generally washed until the filtrate gives only a slightly positive test for chloride ion. The washed presscakes can be dried, ground and used in the form of a coarse or finely divided powder. Alternatively, the azo pigments of this invention can be dispersed into oleoresinous vehicles to prepare flushed bases or dispersed into aqueous vehicles to prepare aqueous dispersions.

In another embodiment, preferred azo pigments comprise one or more compounds characterized by Formula V below: 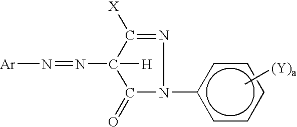
wherein Ar is an aromatic moiety having at least one substituent which is an acid group or salt thereof; X is a hydrocarbyl, carboxylic acid ester, sulfonic acid ester, carboxylic acid amide or sulfonic acid amide group; each Y is independently a hydrocarbyl, halogen, hydrocarbyloxy, carboxylic acid ester, sulfonic acid ester, carboxylic acid amide, imidazolone, sulfonic acid amide or nitro group; and a is 1, 2 or 3.

These azo dyes are prepared by initially diazotizing one or more aromatic amines containing at least one acid group or alkali metal or ammonium salts thereof to form a diazonium component and thereafter coupling the diazonium component with a coupling component comprised of a pyrazolone coupler to form the desired dye.

A variety of suitable aromatic amines may be utilized. Almost any primary aromatic amine can be used where the aromatic moiety of such amine contains at least one substituent acid group or alkali metal or ammonium salts thereof (Ar). The aromatic amines may be monoamines or polyamines containing up to four or more amine groups per molecule. Thus, the diazonium components derived from such amine may contain one diazonium group (mono-diazonium), two diazonium groups (bis-diazonium), three diazonium groups (tris-diazonium), etc. The aromatic amines may be monocyclic amines such as aniline and its derivatives, or bicyclic amines such as naphthyl amine. The aromatic amines may also be biphenylamines or polyamines such as aminobiphenyl, benzidine, and 3, 3′,4,4′-biphenyltetramine.

Preferably, the aromatic amine is a primary aromatic amine characterized by Formula VI below: 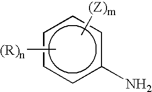
wherein each R is independently a halogen, hydrocarbyl, hydrocarbyloxy, carboxylic acid ester, sulfonic acid ester, carboxylic acid amide, imidazolone, sulfonic acid amide or nitro group; n is 0, 1 or 2; each Z is independently a —COOH or —SO₃H group, or salts of such groups; m is 1 or 2; wherein it is understood that the imidazalone group is represented by the formula —NH—C—NH— which, when taken together with the aromatic ring, the nitrogen atoms are bonded to adjacent carbons to form a five member ring. The term “hydrocarbyl” as used in this specification and claims is intended to include hydrocarbons which may contain substituent groups such as ether, ester, nitro or halogen which do not materially affect the hydrocarbon character of the group.

The aromatic amines characterized by Formula VI above may contain 0, 1 or 2 R groups which are each independently a halogen, hydrocarbyl, hydrocarbyloxy, carboxylic acid ester, sulfonic acid ester, carboxylic acid amide, imidazolone, sulfonic acid amide or nitro group. The halogen group can be any of the halogens, although chlorine and bromine are generally used, with chlorine being the most preferred example of a halogen substituent. The hydrocarbyl groups may independently be alkyl, cycloalkyl, aryl, aralkyl or alkaryl groups. For example, if R is an unsubstituted aryl group, the aromatic amine is a biphenyl amine. When R is an alkyl group, the alkyl group generally will contain from one to four carbon atoms. As used herein, “lower alkyl” shall mean those alkyl groups containing from 1 up to 4 carbon atoms. When R is a hydrocarbyloxy group, the hydrocarbyl moiety may be any of the hydrocarbyl groups discussed above although the hydrocarbyloxy group generally is an alkoxy group containing from 1 to about 4 or more carbon atoms. Preferred R groups are methyl, ethyl and chloro groups.

The aromatic amines characterized by Formula VI above also contain one or two acid groups of —COOH and —SO₃H, or salts thereof. In one preferred embodiment, the aromatic amine of Formula VI above contains an —SO₃H group.

Examples of aromatic amines characterized by Formula VI above wherein Z is a sulfonic acid group and m is 1 include 2-aminobenzene-1-sulfonic acid, 4-aminobenzene-1-sulfonic acid, 2-amino-5-methylbenzene-1-sulfonic acid, 2-amino-5-methoxybenzene-1-sulfonic acid, 3-amino-6-methylbenzene-1-sulfonic acid, 2-amino-4-chloro-5-methylbenzene-1-sulfonic acid, 2-amino-5-chloro-4-ethylbenzene-1-sulfonic acid, 2-amino-5-chloro-4-methylbenzene-1-sulfonic acid, etc.

Examples of aromatic amines characterized by Formula VI above wherein Z is a carboxylic acid group, and m is 1 include 2-aminobenzoic acid, 3-aminobenzoic acid, 4-aminobenzoic acid, 2-amino-5-methylbenzoic acid, 2-amino-6-methylbenzoic acid, 3-amino-2-methylbenzoic acid, 2-amino-3-methoxybenzoic acid, 4-amino-3-methoxybenzoic acid, 4-amino-5-chloro-2-methoxybenzoic acid, 2-amino-4-chlorobenzoic acid, 3-amino-4-chlorobenzoic acid, etc. The benzene sulfonic acid and benzoic acid compounds can be used per se or as their salts. Examples of preferred salts include the alkali metal salts such as the sodium and potassium salts.

The aromatic amines from which the diazonium components are prepared may be fused cyclic aromatic amine compounds such as compounds derived from various naphthalenes including 2-aminonaphthalene-1-sulfonic acid, 4-aminonaphthalene-1-sulfonic acid, etc. Examples of aromatic amines which are biphenyl amines and polyamines include 4-aminobiphenyl-3′-sulfonic acid, and 4,4′-diaminobiphenyl-2,2′-disulfonic acid. Mixtures of two or more of any aromatic amines are within the scope of this invention.

The diazotization of the aromatic amines may be carried out in the manners known to those skilled in the art through the use of alkali metal nitrites or lower alkyl nitrites together with an adequately strong acid such as a mineral acid. Examples of useful mineral acid include hydrochloric acid and sulfuric acid. Nitrosyl sulfuric acid also can be utilized. The diazotization reaction can be conducted at a temperature in the range of from about −20 to +30° C., preferably from 0 to 20° C. Although not required, it may be advantageous in some of the diazotization reactions (and in the subsequent coupling reactions) to include a surface-active agent such as a non-ionic, anionic or cationic surface active agent and, optionally, appropriate organic solvents such as, for example, glacial acetic acid, lower alkanols, dioxane, formamide, dimethyl formamide, dimethyl sulfoxide, pyridine or N-methyl pyrrolidone.

The pyrazolone couplers useful for the purposes of this invention are represented by Formula VII below: 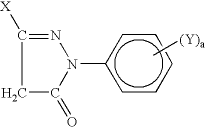
wherein X is a hydrocarbyl, carboxylic acid ester, sulfonic acid ester, carboxylic acid amide or sulfonic acid amide group each Y is independently a hydrocarbyl, halogen, hydrocarbyloxy, carboxylic acid ester, sulfonic acid ester, carboxylic acid amide, imidazolone, sulfonic acid amide or nitro group; and a equals 1, 2 or 3. Alkoxy groups generally contain from 1 up to about 4 carbon atoms. Typically, X is a lower alkyl group containing one or two carbon atoms and is preferably a methyl group. A useful X group is also a carboxylic acid ester of an alcohol containing 1 or 2 carbon atoms and is preferably an ethyl ester group.

Typically, each Y is independently a lower alkyl or halogen group. The halogen group can be any of the halogens, although chlorine and bromine are generally used, with chlorine being the most preferred example of a halogen substituent. Usually, the lower alkyl groups contain one or two carbon atoms and a methyl group is a preferred substituent. Preferably, a is 1 or 2. A particularly useful embodiment is when a is 1 and Y is a methyl group in the 4 position.

Examples of the useful pyrazolone couplers include 1-(4′-methylphenyl)-3-methyl-5-pyrazolone, 1-(4′-chlorophenyl)-3-methyl-5-pyrazolone, 1-(4′methylphenyl)-3-carbethoxy-5-pyrazolone, etc. Mixtures of two or more of any of the pyrazolone components are within the scope of this invention.

The coupling reaction may be effected preferably by adding the diazonium components to coupling components, but the coupling components can be added to the diazonium components. Coupling is generally effected at a temperature of from about −20 to about 80° C., preferably from about. 20 to about 65° C. As in a diazotization reaction, coupling may be carried out in the presence of an appropriate surface active agent or organic solvent, such as all of those identified above for the diazotization reaction.

The coupling component may be dissolved in a basic solution such as an aqueous alkali metal hydroxide solution and reprecipitated with a dilute acid such as acetic acid.

The diazonium component may also be coupled with a slight stoichiometric excess of the coupling component. That is, one equivalent of the diazonium component is coupled with slightly more than one equivalent of the coupling component.

The dispersibility of the pigments may be improved by adding alkali-soluble resin-like products before, during, or after the coupling is completed or after the metallization discussed below. Various resin-like materials can be added for this purpose, and these include for example, rosin resins, polymeric rosins, resin soap, chemically modified rosin resins such as rosin-maleinate resins, alkyd resins, and other synthetic hydrocarbon resins with a higher acid number, or combination of these resins. The resins may be present in a product with free carboxyl groups that are capable of forming a salt, or may be partially or completely in the form of salts, for example, with alkali metal ions. It may also be advantageous to perform the coupling reaction in the presence of a finely divided insoluble material, for example, alkaline earth metal sulphates and carbonates, titanium dioxide or clay materials or very finely divided organic plastic materials.

The composition prepared by the above-described coupling reaction can be metallized by a divalent metal salt which forms the sulfonate or carboxylate salt. This is also known as laking and forms the azo pigment. The metal salt may be a salt of alkaline earth metals, manganese, nickel or zinc or mixtures of two or more of these metals. Alkaline earth metal salts are preferred. Alkaline earth metal salts such as SrC1₂ and CaC1₂ are particularly useful for this purpose. Metallization may be accomplished preferably by adding the metal salt to the dye after coupling of all the diazonium component present is complete or, by including the metal salt in the diazonium component whereby metallization occurs as the dye is formed.

In most applications, it is desirable, in order to achieve the full brightness and tinctorial strength, to heat the azo pigment. For example, the product of the metallization may be heated to reflux temperature for about 1 to 3 hours or at temperatures above 100° C. under pressure in the presence of the above-described resin soaps or other soluble resins.

After completion of the metallization, the azo pigments are recovered from the water-based reaction slurry by filtering to form a presscake of pigment which is washed with hot (e.g., 40-60° C.) water so as to remove the excess acids, bases and salts formed in the coupling reaction. The presscake is typically washed with from about 10 to 20 times its volume of hot water. The filter cake is generally washed until the filtrate gives only a slightly positive test for chloride ion. The washed presscakes can be dried, ground and used in the form of a coarse or finely divided powder. Alternatively, the azo pigments of this invention can be dispersed into oleoresinous vehicles to prepare flushed bases or dispersed into aqueous vehicles to prepare aqueous dispersions.

In a third embodiment, other preferred azo pigments comprise one or more compounds characterized by Formula VIII below: 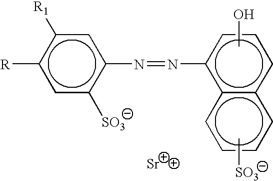
wherein R and R₁ are independently hydrogen, chloro, methyl or ethyl groups.

These azo pigments are prepared by initially diazotizing one or more aromatic amines and thereafter coupling the diazonium component with a coupling component to form the desired pigment.

Aromatic amines suitable for the purposes of the preferred pigment are those characterized by Formula IX below:

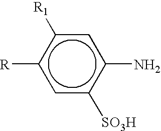

Preferred azo pigments are prepared by initially diazotizing one or more aromatic amines suitable for use in this invention and thereafter coupling the diazonium component with a coupling component suitable for use in this invention to form the desired pigment.

Aromatic amines suitable for the purposes of the preferred pigment are those characterized by the formula: 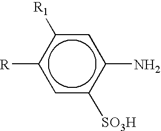
wherein R and R₁ are independently hydrogen, chloro, methyl or ethyl groups.

Examples of aromatic amines are 2-amino-4-chloro-5-methylbenzenesulfonic acid, 2-amino-5-chloro-4-methylbenzenesulfonic acid, 2-amino-5-chloro-4-ethylbenzenesulfonic acid, and 2-amino-5-methylbenzenesulfonic acid. Mixtures of two or more aromatic amines may be used.

The diazotization of the aromatic amines may be carried out in the manners known to those skilled in the art through the use of alkali metal nitrites or lower alkyl nitrites together with an adequately strong acid such as a mineral acid. Examples of useful mineral acid include hydrochloric acid and sulfuric acid. Nitrosyl sulfuric acid can also be utilized. The diazotization reaction can be conducted at a temperature in the range of from about −20 to +30° C., preferably from 0 to 15° C. Although not required, it may be advantageous in some of the diazotization reactions (and in the subsequent coupling reactions) to include a surface-active agent such as a non-ionic, anionic or cationic surface active agent and, optionally, appropriate organic solvents such as, for example, glacial acetic acid, lower alkanols, dioxane, formamide, dimethyl formamide, dimethyl sulfoxide, pyridine or N-methyl pyrrolidone.

The hydroxynaphthalenesulfonic acid couplers useful for the purposes of this invention are represented by the formula:

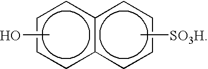

Examples of the hydroxynaphthalenesulfonic acid couplers useful for the purposes of this invention include 1-naphthol-4-sulfonic acid, 1-hydroxynaphthalene-4-sulfonic acid, 1-hydroxynaphthalene-5-sulfonic acid, 1-hydroxynaphthalene-8-sulfonic acid, 2-hydroxynaphthalene-6-sulfonic acid, etc. Mixtures of two or more of any of the hydroxynaphthalenesulfonic acid couplers may be used.

The coupling reaction useful for the purposes of the present invention may be effected preferably by adding the diazonium components to coupling components, but the coupling components can be added to the diazonium components. Coupling is generally effected at a temperature of from about −20 to about 80° C., preferably from about 0 to about 60° C. and at a pH of from 4 to 12, preferably from about 5 to 11. As in a diazotization reaction, coupling may be carried out in the presence of an appropriate surface active agent or organic solvent, such as all of those identified above for the diazotization reaction.

Generally, the coupling component is dissolved in a basic solution such as an aqueous alkali metal hydroxide solution and reprecipitated with a dilute acid such as acetic acid.

Generally, the diazonium component is coupled with a slight stoichiometric excess of the coupling component. That is, one equivalent of the diazonium component is coupled with slightly more than one equivalent of the coupling component.

The dispersibility of the pigments of the present invention can be improved by adding alkali-soluble resin-like products before, during, or after the coupling is completed or after the metallization discussed below. Various resin-like materials can be added for this purpose, and these include for example, rosin resins, polymeric rosins, resin soap, chemically modified rosin resins such as rosin-maleinate resins, alkyd resins, and other synthetic hydrocarbon resins with a higher acid number, or combination of these resins. The resins may be present in a product with free carboxyl groups that are capable of forming a salt, or may be partially or completely in the form of salts, for example, with alkali metal ions. It may also be advantageous to perform the coupling reaction in the presence of a finely divided insoluble material, for example, alkaline earth metal sulphates and carbonates, titanium dioxide or clay materials or very finely divided organic plastic materials.

The composition prepared by the above-described coupling reaction can be metallized by one or more strontium salts which form the sulfonate salt. This is also known as laking and forms the azo pigment. SrC1₂ and SrNO₃ are particularly useful for this purpose. Metallization may be accomplished preferably by adding the strontium salt to the dye after coupling of all the diazonium component present is complete or, by including the strontium salt in the diazonium component whereby metallization occurs as the dye is formed.

It is desirable, in order to achieve the full brightness and tinctorial strength, to heat the azo pigment. For example, the product of the metallization may be heated to reflux temperature for about 1 to 3 hours or at temperatures above 100° C. under pressure in the presence of the above-described resin soaps or other soluble resins.

After completion of the metallization, the azo pigments are recovered from the water-based reaction slurry by filtering to form a presscake of pigment which is washed with water so as to remove the excess acids, bases and salts formed in the coupling reaction. The presscake is typically washed with from about 10 to 20 times its volume of water. The filter cake is generally washed until the filtrate gives only a slightly positive test for chloride ion. The washed presscakes can be dried, ground and used in the form of a coarse or finely divided powder. Alternatively, the azo pigments of this invention can be dispersed into oleoresinous vehicles to prepare flushed bases or dispersed into aqueous vehicles to prepare aqueous dispersions.

Although U.S. Pat. Nos. 5,669,967; 5,746,821; 5,677,435; and 5,747,571 teach that the disclosed pigments are useful as coloring agents in laquer and thermoplastic material such as polyester, no mention is made of polymeric films and the difficulty associated with incorporation of colorants therein and the need for solvent stability. More preferred pigments include Pigment Blue 29 and organic pigments such as Pigment Violet 19, Pigment Red 178, C.I. Pigment Red 276, C.I. Pigment Red 277, C.I. Pigment Yellow 205, C.I. Pigment Yellow 206, C.I. Pigment Blue 15:3, Pigment Blue 29, Pigment Black 7, and Pigment Green 7. The most preferred pigments are characterized by Formulae I, V, and VIII above Although Engelhard product brochure “Organic Pigments for Plastics” (dated 2002) teach organic pigments that are useful for plastics, no mention is made of polymeric films and the difficulty associated with incorporation of colorants therein and the need for solvent stability wherein disruption of the microlayers impacts the color and thus, changes the parallel nature of the adjacent microlayers and iridescent quality. Preferably, the pigments are used in the iridescent films at between about 0.1% to about 5% by weight.

Polymers:

The phrase “substantially parallel layers” means that adjacent layers remain generally in the x-y plane and have minimal or no z direction shift.

Preferably, the first and second polymers of the present invention have indices of refraction that differ by at least about 0.03 and preferably 0.06. These films contain preferably at least about 10 layers, more preferably at least about 35 layers, and most preferably at least about 70 layers. The individual layers of the film are very thin, usually in the range of preferably about 15 nanometers (nm) to about 500 nm, and more preferably about 50 nm to about 400 nm. Preferably, the thickness of the inner layers ranges from about 15 nm to about 200 nm and the thickness of the outer layers ranges from about 1 to about 2 microns. Preferred polymers include polyesters, polyacrylates, polyethylene vinyl acetate, and polystryenes. Preferred polyesters include polyethylene terephthalate, polybutylene terephthalate, glycol modified polyethylene terephthalate, and polyethylene naphthalate as disclosed in commonly assigned U.S. Pat. No. 6,475,608, incorporated herein by reference. Preferred polyacrylates include polymethyl methacrylate. One preferred film has alternating layers of polybutylene terephthalate and polymethyl methacrylate. Another preferred film has alternating layers of PBT and EVA. Another preferred film has alternating layers of polyethylene terephthalate and polymethyl methacrylate or polyolefin. Another preferred film has alternating layers of polystyrene and ethylene vinyl acetate. Another preferred film has alternating layer of polyethylene naphthalate and polymethyl methacrylate or PET.

The multilayer films are usually made by a chill-roll casting technique in which melts of the thermoplastic resinous material from two or more extruders are collected by a feedblock which arranges them into a desired layered pattern. The very narrow multilayer stream flows through a single manifold flat film die with the layers simultaneously spread to the width of the die and thinned to the final die exit thickness. The number of layers and their thickness distribution can be changed by using a different feedblock module. Usually, the outermost layer or layers on each side of the sheet is thicker than the other layers so as to form a relatively thick skin. The resinous material used to form the skin may be one of the components which makes up the optical core, or a different polymer which is utilized to impart a desirable mechanical, heat sealing or other property, or a combination of these. Preferably, the present film is made by a process disclosed in U.S. Pat. No. 3,801,429, incorporated herein by reference to the extent necessary to complete this disclosure.

In accordance with the invention, a pigment is added to one or more of the resinous materials in an amount which is sufficient to result in an enhancement or in a change of at least one of the reflection colors of the film or one of the transmission colors of the film, or both, relative to the same characteristic present when the pigment is not used. The pigment may be incorporated in all or less than all of the layers of the optical core and/or in all or less than all of the skin layers. Thus, the pigment may be incorporated in at least one of the core or skin layers. The number of layers in which the pigment is incorporated and the concentration of the pigment in an individual layer is a function of the desired color effect.

Utility:

The present invention is useful in decorative applications. For example, the present invention may be sized reduced in some manner to form glitter particles. These particles are of various size and shape depending on the application. The size ranges from very small, approximately 0.004″, to larger particles such as sequins. The shapes may range from geometric shapes such as hexagons to decorative shapes like hearts. Once the present film is cut into the size and shape desired, the cuttings are filtered to remove off standard material and treated to improve flowability. The problem with current glitter films is that any colorant used has not been stable to organic solvents such as those used in nail lacquer formulations. The present organic pigments used in the new formulations are stable to organic solvents allowing the resulting glitter to be used in formulations with organic solvents.

The present invention is also useful in textiles. The present film may be first laminated to polyester film to increase the tensile strength of the film. The resulting laminated structure is then micro-slit into yarn. This yarn can then be used as is or twisted with other yarns before being converted into fabric. The current colorants do not perform well in two key areas. The first area is stability to solvents such as dry cleaning fluid or water with detergents. The current colorants will leach out of the film and stain other fibers in the same solution. The second area of concern is light exposure. Current colorants will fade overtime when exposed to simulated sunlight. The organic pigments used in the new formulations do not have the stability problems seen with the current colorants. This improvement will allow the textile industry to have a wider range of colors to offer on the market.

Comparative A:

A 226 layer iridescent film was made by co-extruding alternating layers of PBT and EVA. C.I. Solvent Red 13.5 dye was incorporated into the PBT prior to film formation. The film showed good iridescent and color.

Then, glitter made from this film was used to make a nail lacquer by combining the components in Table 1 below in an appropriate size vessel with a Lightnin™ type propeller mixer. Mixing continued until the batch was uniform.

TABLE 1

| COMPONENT | WEIGHT PERCENT |
|---|---|
| Suspending Lacquer SLF-2 (comprises butyl | 82.00 |
| acetate, toluene, nitrocellulose, | |
| tosylamide/formaldehyde resin, isopropyl | |
| alcohol, dibutyl phthalate, ethyl acetate, | |
| camphor, n-butyl alcohol, silica, and | |
| quaternium-18 hectorite) | |
| Lacquer 127P (comprises butyl acetate, | 15.00 |
| toluene, nitrocellulose, tosylamide/ | |
| formaldehyde resin, isopropyl alcohol, | |
| dibutyl phthalate, ethyl acetate, | |
| camphor, and n-butyl alcohol) | |
| Glitter Comprised of Comparative Film | 3.00 |

The glitter in the nail lacquer kept its iridescence; however, the dye bled out of the glitter into the solvents and thus, the glitter was no longer colored.

Comparative B:

A 115 layer iridescent film was made by co-extruding alternating layers of PET and PMMA. Dye was incorporated into the PET prior to film formation. The film showed good iridescent and color.

Then, glitter made from this film was used to make a nail lacquer as described in Comparative A above. The dye bled out of the glitter into the solvents and thus, the glitter was no longer colored or iridescent. The film in the glitter swelled and thus, the glitter was no longer iridescent.

Comparative C:

Comparative B was repeated except that a 226 layer film was formed. The film showed good iridescent and color.

Then, glitter made from this film was used to make a nail lacquer as described above. The dye bled out of the glitter into the solvents and thus, the glitter was no longer colored or iridescent.

Comparative D:

A 115 layer iridescent film was made by co-extruding alternating layers of PBT and PMMA. Dye was incorporated into the PBT prior to film formation. The film showed good iridescent and color.

Then, glitter made from this film was used to make a nail lacquer as described in Comparative A above. The dye bled out of the glitter into the solvents and thus, the glitter was no longer colored or iridescent.

The following preparations and examples illustrate the compositions of the present invention and their methods of preparation. Unless otherwise indicated in the following examples and elsewhere in the specification and claims, all parts and percentages are by weight, temperatures are in degrees centigrade and pressures are at or near atmospheric.

Preparation of Pigment I:

A diazo slurry is prepared by dissolving 23.7 parts 2-amino-5-chloro-4-ethylbenzene-1-sulfonic acid (Ethyl C Amine) in 370 parts hot (˜60° C.) water containing 4 parts sodium hydroxide, repreciptating the Ethyl C Amine with 26.0 parts 20° Baume hydrochloric acid, adding ice to make a 0° slurry, adding 7.0 parts sodium nitrite dissolved in 21 parts water and stirring the slurry at 0-10° for 60 minutes.

A coupler slurry is prepared by using 23.0 parts 1-(2′-chlorophenyl)-3-methyl-5-pyrazolone (OCPMP), 2.3 parts of the sodium salt of sulfated castor oil, and 9.6 parts of sodium acetate, and heating the slurry to 65°.

The diazo slurry is coupled into the coupler slurry over a period of 20 minutes, while the pH is maintained at 6.0-6.5 by addition of 10% sodium hydroxide and the temperature is maintained at 60-65°. The slurry is stirred for one hour, then split to give four equal parts of slurry I.

To one part (525 parts) of slurry I at 65° are added 12.3 parts of 30% calcium chloride dehydrate solution. The slurry is then heated, boiled for 30 minutes, iced to lower than 40°, and filtered; the filtercake is washed, dried overnight at 70°, and pulverized in an Osterizer to give a fine powder Pigment 1.

Preparation of Pigment II

A diazo slurry is prepared by dissolving 22.2 parts 2-amino-5-chloro-4-methylbenzene-1-sulfonic acid (C Amine) in 390 parts water containing 4.0 parts sodium hydroxide, reprecipitating the C Amine with 26.0 parts 20° Baume hydrochloric acid, adding ice to make a 0° slurry, adding 7.0 parts sodium nitrite dissolved in 14 parts water and stirring the slurry at 0-5° for 60 minutes.

A coupler slurry is prepared by dissolving 20.7 parts 1-(4′-methylphenyl)-3-methyl-5-pyrazolone (PTMP) in 205 parts water containing 4.5 parts sodium hydroxide at about 40°, reprecipitating the PTMP with 67.5 parts 10% acetic acid, adjusting the pH to 6.5, and heating the slurry to 60-65°.

The diazo slurry is coupled into the coupler slurry over a period of 20 minutes, while the pH is maintained at 6.0-6.5 by addition of 10% sodium hydroxide arid the temperature is maintained at 60-65°. The slurry is stirred and heated for one hour, then split to give four equal parts of slurry II.

To one part of slurry II at 40-45° are added 12.3 parts of 30% calcium chloride dehydrate solution. The slurry is then heated, boiled for 30 minutes, iced to lower than 50°, and filtered; the filtercake is washed with hot water, dried overnight at 70°, and pulverized in an Osterizer to give a fine powder Pigment II.

Preparation of Pigment III

A diazo slurry is prepared by dissolving a mixture of 4.05 parts of 2-amino-4-chloro-5-methylbenzenesulfonic acid and 4.3 parts of 2-amino-5-chloro-ethylbenezenesulfonic acid in 250 parts of water and 3.3 parts of 50% sodium hydroxide solution. This solution is cooled to 0° C. by the addition of ice and diazotized by the addition of 10.5 parts of a 25% solution of sodium nitrite and 11 parts of 20° Baume hydrochloric acid and stirring the slurry at 0-1° C. for 30 minutes. Excess nitrite is quenched with sulfamic acid. A small amount of antifoam is used to control the foam.

A coupler slurry is prepared by dissolving 10 parts of potassium slat of 2-hydroxy-naphthalene-6-sulfonic acid (Schaeffer's Salt) by heating in 200 parts of water and 3 parts of 50% sodium hydroxide and cooled to 20° C. with ice.

The diazo slurry is coupled into the coupler slurry over a period of 10-15 minutes. The pH of the slurry is raised to between 9.8 and 10 by addition of 10 percent solution of sodium hydroxide. The mixture is stirred 40 minutes and heated at a rate of approximately 1° C./minute. Forty parts of a 30% solution of strontium nitrate are added over a period of approximately 30 minutes while the temperature of a batch is held at between 45 and 50° C. The slurry is then heated to boil and boiled for 25 minutes. The slurry is then iced to lower than 45° C. and filtered; the filtercake is washed with water, dried overnight at 70° C., and pulverized to give a powder Pigment III.

Preparation of Pigment IV:

The preparation of Pigment III above is repeated except that a mixture of 2-amino-5-chloro-4-ethylbenzenesulfonic acid (7.6 parts) and 2-aminonaphthalene-1-sulfonic acid (1 part) was used in place of a mixture of 4.05 parts of 2-amino-4-chloro-5-methylbenzenesulfonic acid and 4.3 parts of 2-amino-5-chloro-4-ethylbenzenesulfonic acid.

### INVENTIVE EXAMPLE 1

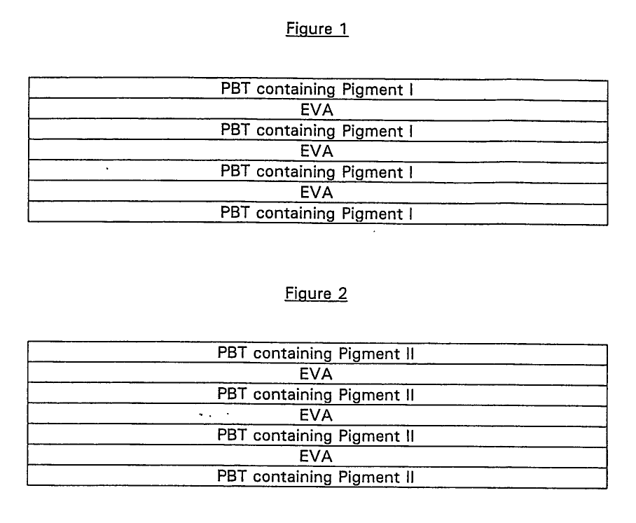

A 226 layer iridescent film was produced by co-extruding alternating layers of PBT and EVA. Pigment I above was incorporated into the PBT prior to the film formation. The final film had a thickness of 0.014 inch. Each inner PBT layer had about the same thickness and each inner EVA layer had about the same thickness. FIG. 1 illustrates the cross section of seven inner layers of this 226 layer iridescent film. The film showed good iridescence (red yellow) and color (tinted yellow).

Then, glitter made from this film was used to make a nail lacquer formulation by combining the components in Table 2 below in an appropriate size vessel with a Lightnin™ type propeller mixer. Mixing continued until the batch was uniform.

TABLE 2

| COMPONENT | WEIGHT PERCENT |
|---|---|
| Suspending Lacquer SLF-2 (comprises | 82.00 |
| butyl acetate, toluene, nitrocellulose, | |
| tosylamide/formaldehyde resin, isopropyl | |
| alcohol, dibutyl phthalate, ethyl acetate, | |
| camphor, n-butyl alcohol, silica, and | |
| quaternium-18 hectorite) | |
| Lacquer 127P (comprises butyl acetate, | 15.00 |
| toluene, nitrocellulose, tosylamide/ | |
| formaldehyde resin, isopropyl alcohol, | |
| dibutyl phthalate, ethyl acetate, | |
| camphor, and n-butyl alcohol) | |
| Glitter Comprised of Inventive Example | 3.00 |
| Film | |

In contrast to Comparative A above, Pigment I did not bleed out of the glitter into the solvents and thus, the glitter remained colored and iridescent. Thus, a solvent stable colored (tinted yellow) iridescent (red yellow) film and glitter were formed.

### INVENTIVE EXAMPLE 2

The film preparation of Inventive Example 1 above was repeated except that the pigment used was Pigment II described above. FIG. 2 illustrates the cross section of seven inner layers of this resulting 226 layer film. The film showed good iridescence (red yellow) and color (reddish yellow).

Then, glitter made from this film was used to make a nail lacquer as described in Inventive Example I above. In contrast to Comparative A above, Pigment II did not bleed out of the glitter into the solvents and thus, the glitter remained colored and iridescent. Thus, a solvent stable colored (reddish yellow) iridescent (red yellow) film and glitter were formed.

### INVENTIVE EXAMPLE 3

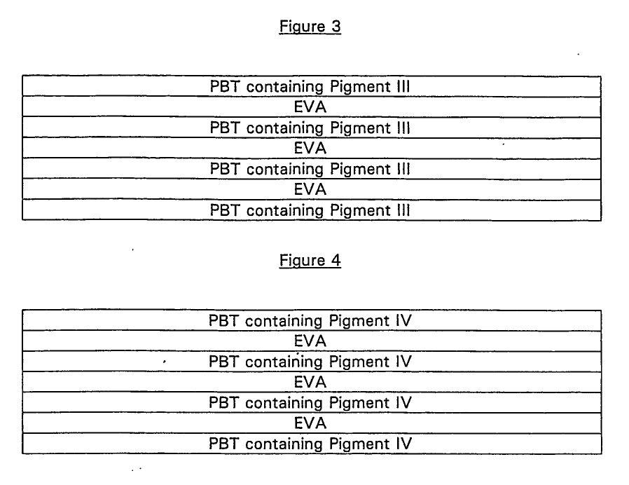

The film preparation of Inventive Example 1 above was repeated except that the pigment used was Pigment III described in above. FIG. 3 illustrates the cross section of seven inner layers of this resulting 226 layer film. The film showed good iridescence (red yellow) and color (yellowish red).

Then, glitter made from this film was used to make a nail lacquer as described in Inventive Example 1 above. In contrast to Comparative A above, Pigment III did not bleed out of the glitter into the solvents and thus, the glitter remained colored and iridescent. Thus, a solvent stable colored (yellowish red) iridescent (red yellow) film and glitter were formed.

### INVENTIVE EXAMPLE 4

The film preparation of Inventive Example 1 above was repeated except that the pigment used was Pigment IV described above. FIG. 4 illustrates the cross section of seven inner layers of this resulting 226 layer film. The film showed good iridescence (blue violet) and color (tinted red).

Then, glitter made from this film was used to make a nail lacquer as described in Inventive Example 1 above. In contrast to Comparative A above, Pigment IV did not bleed out of the glitter into the solvents and thus, the glitter remained colored and iridescent. Thus, a solvent stable colored (tinted red) iridescent (blue violet) film and glitter were formed.

### INVENTIVE EXAMPLE 5

A 115 layer iridescent film of alternating layers of PBT and PMMA is produced. Pigment I described above is incorporated into the PBT prior to the film formation. FIG. 5 illustrates the cross section of seven inner layers of this 115 layer iridescent film.

### INVENTIVE EXAMPLE 6

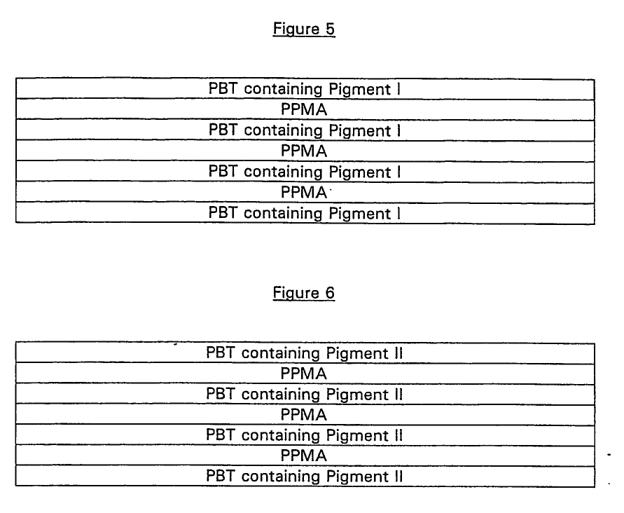

Inventive Example 5 is repeated except that Pigment II described above is incorporated into the PBT prior to the film formation. FIG. 6 illustrates the cross section of seven inner layers of this 115 layer iridescent film.

### INVENTIVE EXAMPLE 7

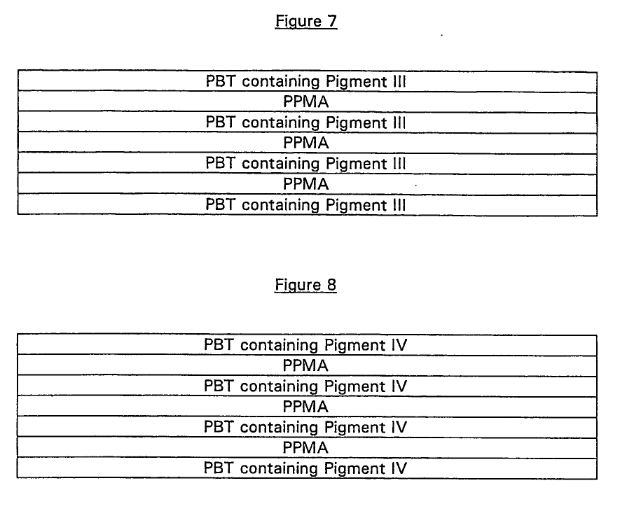

Inventive Example 5 is repeated except that Pigment III described above is incorporated into the PBT prior to the film formation. FIG. 7 illustrates the cross section of seven inner layers of this 115 layer iridescent film.

### INVENTIVE EXAMPLE 8

Inventive Example 5 is repeated except that Pigment IV described above is incorporated into the PBT prior to the film formation. FIG. 7 illustrates the cross section of seven inner layers of this 115 layer iridescent film.

### INVENTIVE EXAMPLE 9

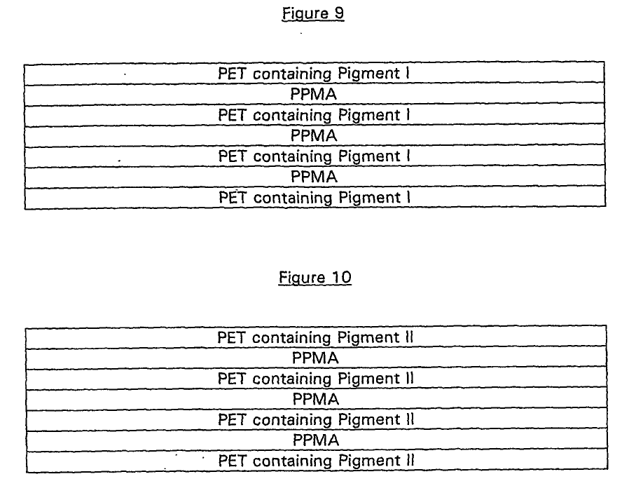

A 115 layer iridescent film of alternating layers of PET and PPMA is produced. Pigment I described above is incorporated into the PET prior to the film formation. FIG. 9 illustrates the cross section of seven inner layers of this 115 layer iridescent film.

### INVENTIVE EXAMPLE 10

Inventive Example 9 is repeated except that Pigment II described above is incorporated into the PET prior to the film formation. FIG. 10 illustrates the cross section of seven inner layers of this 115 layer iridescent film.

### INVENTIVE EXAMPLE 11

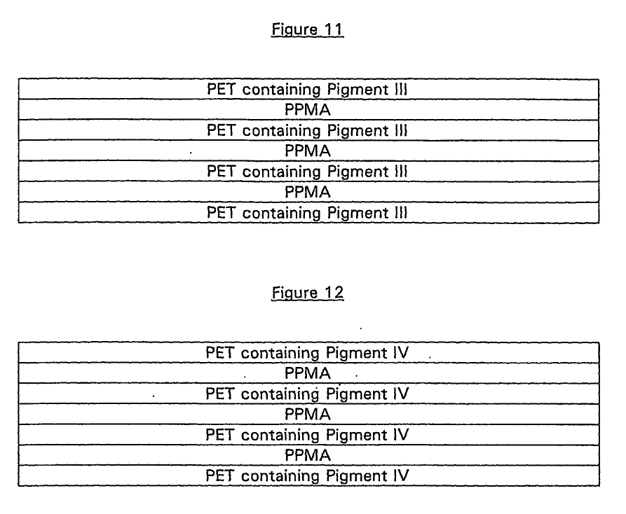

Inventive Example 9 is repeated except that Pigment III described above is incorporated into the PET prior to the film formation. FIG. 11 illustrates the cross section of seven inner layers of this 115 layer iridescent film.

### INVENTIVE EXAMPLE 12

Inventive Example 9 is repeated except that Pigment IV described above is incorporated into the PET prior to the film formation. FIG. 12 illustrates the cross section of seven inner layers of this 115 layer iridescent film.

### INVENTIVE EXAMPLES 13-16

Inventive Examples 9-1 2 are repeated except that a 226 layer film is made.

### INVENTIVE EXAMPLE 17

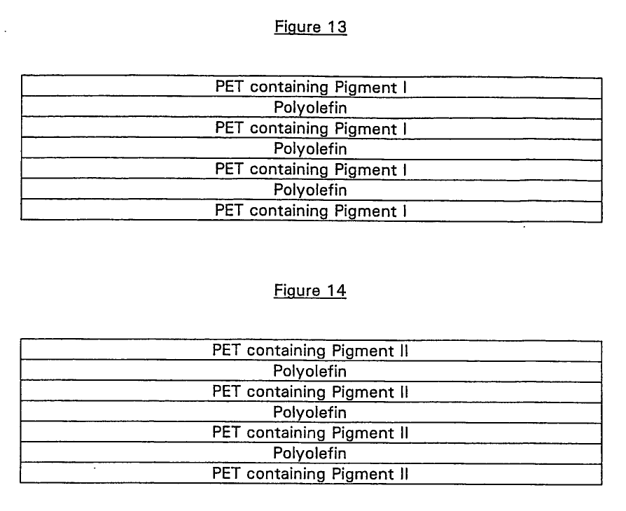

A 115 layer iridescent film of alternating layers of PET and polyolefin such as polyethylene or polypropylene is produced. Pigment I described above is incorporated into the PET prior to the film formation. FIG. 13 illustrates the cross section of seven inner layers of this 115 layer iridescent film.

### INVENTIVE EXAMPLE 18

Inventive Example 17 is repeated except that Pigment II described above is used. FIG. 14 illustrates the cross section of seven inner layers of this 115 layer iridescent film.

### INVENTIVE EXAMPLE 19

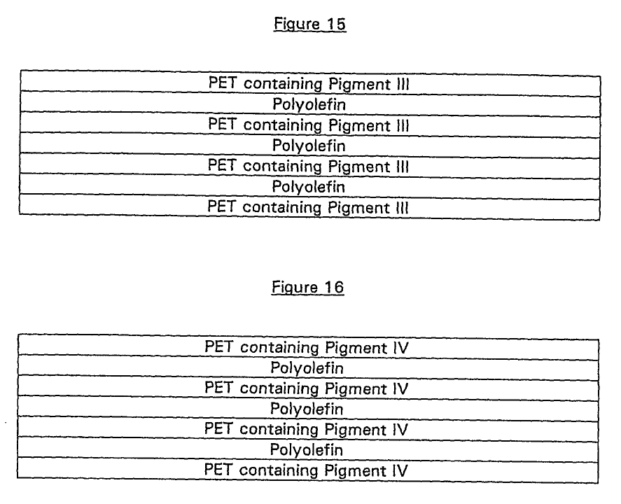

Inventive Example 17 is repeated except that Pigment III described above is used. FIG. 15 illustrates the cross section of seven inner layers of this 115 layer iridescent film.

### INVENTIVE EXAMPLE 20

Inventive Example 17 is repeated except that Pigment IV described above is used. FIG. 16 illustrates the cross section of seven inner layers of this 115 layer iridescent film.

### INVENTIVE EXAMPLE 21

A 115 layer iridescent film of alternating layers of PBT and polyethylene naphthalate (hereinafter “PEN”) is produced. Pigment I described above is incorporated into the PBT prior to the film formation. FIG. 17 illustrates the cross section of seven inner layers of this 115 layer iridescent film.

### INVENTIVE EXAMPLE 22

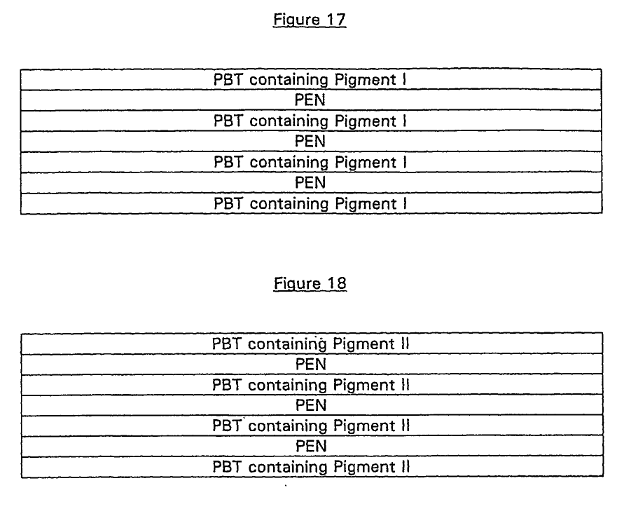

Inventive Example 21 is repeated except that Pigment II described above is used. FIG. 18 illustrates the cross section of seven inner layers of this 115 layer iridescent film.

### INVENTIVE EXAMPLE 23

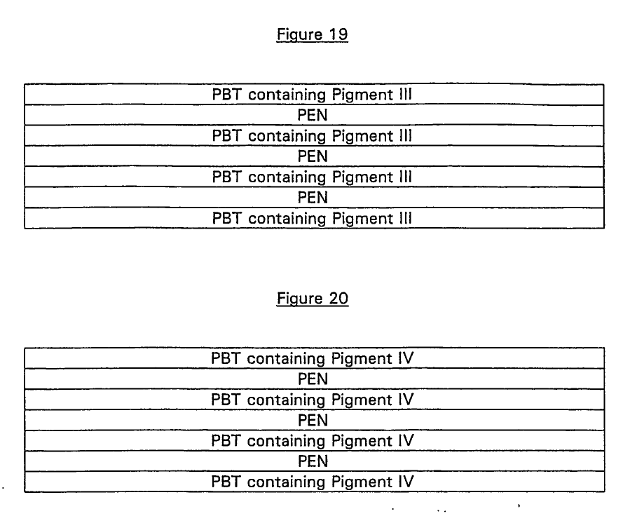

Inventive Example 21 is repeated except that Pigment III described above is used. FIG. 19 illustrates the cross section of seven inner layers of this 115 layer iridescent film.

### INVENTIVE EXAMPLE 24

Inventive Example 5 is repeated except that Pigment IV described above is used. FIG. 20 illustrates the cross section of seven inner layers of this 115 layer iridescent film.

### INVENTIVE EXAMPLE 25-28

Inventive Examples 21-24 are repeated except that a 226 layer is formed.

What is claimed is:

1. Colored iridescent film comprising a core of substantially parallel layers wherein alternate of said layers comprise a first polymer and the remaining layers comprise a second polymer and at least one of said layers contains organic pigment.

2. The colored iridescent film of claim 1 wherein said organic pigment is selected from the group consisting of phthalocyanines, perylenes, quinacridones, and azo compounds.

3. The colored iridescent film of claim 2 wherein said azo compound comprises one or more compounds characterized by Formula I below: 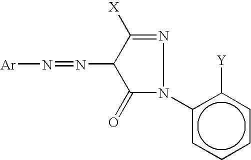
wherein X is a hydrocarbyl, carboxylic acid ester, sulfonic acid ester, carboxylic acid amide or sulfonic acid amide group; Y is a hydrocarbyl, halogen or hydrocarbyloxy group; and Ar is an aromatic moiety characterized by Formula II below: 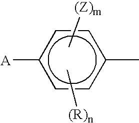
wherein A is a halogen group; each Z is independently a —COOH or —SO₃H group, or salts of such groups; m is 1 or 2; each R is independently a halogen, hydrocarbyl, hydrocarbyloxy, carboxylic acid ester, sulfonic acid ester, carboxylic amide, imidazolone, sulfonic acid amide or nitro group; and n is 0, 1 or 2.

4. The colored iridescent film of claim 2 wherein said azo compound comprises one or more compounds characterized by Formula V below: 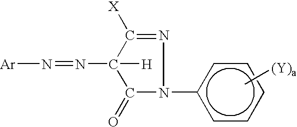
wherein Ar is an aromatic moiety having at least one substituent which is an acid group or salt thereof; X is a hydrocarbyl, carboxylic acid ester, sulfonic acid ester, carboxylic acid amide or sulfonic acid amide group; each Y is independently a hydrocarbyl, halogen, hydrocarbyloxy, carboxylic acid ester, sulfonic acid ester, carboxylic acid amide, imidazolone, sulfonic acid amide or nitro group; and a is 1, 2 or 3.

5. The colored iridescent film of claim 2 wherein said azo compound comprises one or more compounds characterized by Formula VIII below: 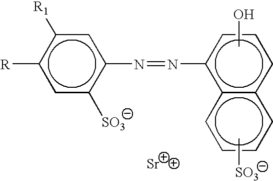
wherein R and R₁ are independently hydrogen, chloro, methyl or ethyl groups.

6. The colored iridescent film of claim 1 wherein said organic pigment is present in at least one outer layer.

7. The colored iridescent film of claim 1 wherein said organic pigment is present in at least one inner layer.

8. The colored iridescent film of claim 1 wherein the thickness of at least one of said core outer layers is greater than the thickness of at least one of said core inner layers.

9. Glitter made of said colored iridescent film of claim 1.

10. Nail lacquer containing said glitter of claim 9.
